(19) United States
(12) Patent Application Publication
(10) Pub. No.: US 2021/0125499 A1
(43) Pub. Date: Apr. 29, 2021

(54) VARIABLE RANGE OFFERINGS FOR LIGHT ELECTRIC VEHICLES BASED ON USER PROFILES

(71) Applicant: Uber Technologies, Inc., San Francisco, CA (US)

(72) Inventors: Ashley Cooper, San Francisco, CA (US); Nicholas Foley, San Francisco, CA (US); Ke Bin Wu, San Francisco, CA (US)

(21) Appl. No.: 17/079,161

(22) Filed: Oct. 23, 2020

Related U.S. Application Data
(60) Provisional application No. 62/925,163, filed on Oct. 23, 2019.

(51) Int. Cl. G08G 1/00; G06Q 10/02; B60L 58/10; G06Q 30/06

(52) U.S. Cl. CPC G08G 1/205; G06Q 10/02; B60L 3/12; G06Q 30/0645; G06Q 30/0627; B60L 58/10

(57) ABSTRACT

The present disclosure describes how to determine a range offering for a light electric vehicle. The range offering may be based on riding habits of an individual that provides a reservation or use request to ride the light electric vehicle and on information associated with the light electric vehicle. The range offering may be used to determine whether a light electric vehicle can or should be used by an individual to transport the individual from an origin to a destination.

### CROSS-REFERENCE TO RELATED APPLICATION

This application claims priority to U.S. Provisional Application No. 62/925,163 titled Variable Range Offerings for Light Electric Vehicles Based on User Profiles, filed on Oct. 23, 2019, the entire disclosure of which is hereby incorporated by reference in its entirety.

### BACKGROUND

Electric vehicles, such as electric scooters and electric bicycles, are typically available for individuals to reserve and ride for a period of time. However, each individual that reserves and rides these electric vehicles may have different experience levels. Additionally, each individual may travel from different origins to different destinations along a number of different routes.

### SUMMARY

The present disclosure describes determining a range offering for a light electric vehicle. As will be explained in greater detail below, the range offering may be based on riding habits of the individual and on information associated with the light electric vehicle. The range offering may be used to determine whether a light electric vehicle can or should be used by an individual to transport the individual from an origin to a destination.

Accordingly, the present disclosure describes a method for determining a range offering for a light electric vehicle. The method may be performed by a light electric vehicle management system and includes receiving a light electric vehicle use request from a computing device associated with an individual. The light electric vehicle management system may then determine, based at least in part, on the light electric vehicle use request, profile information of the individual and a location of the individual. The light electric vehicle management system may also determine, based at least in part, on the profile information of the individual and the location of the individual, an anticipated route of travel of the individual. The light electric vehicle management system may also identify, using light electric vehicle profile information received from a plurality of light electric vehicles and the profile information of the individual, one or more light electric vehicles associated with the location of the individual and that have a range offering that enables the individual to complete the anticipated route of travel. The light electric vehicle management system may then provide a location of at least one of the one or more light electric vehicles to the computing device associated with the individual.

The present disclosure also describes a method for identifying a particular light electric vehicle for an individual having a riding experience below a riding experience threshold. For example, a light electric vehicle management system may receive a light electric vehicle use request from a computing device associated with an individual. The light electric vehicle management system may determine or otherwise identify, based at least in part, on the light electric vehicle use request, profile information of the individual and a location of the individual. The light electric vehicle management system may also determine, based at least in part, on the profile information of the individual, whether a number of uses of light electric vehicles by the individual is below a threshold. The light electric vehicle management system may identify one or more light electric vehicles associated with the location of the individual and select at least one of the light electric vehicles based, at least in part, on light electric vehicle profile information. The light electric vehicle management system may then provide a location of the identified light electric vehicle to the computing device associated with the individual.

Also described is a system having at least one processor and a memory communicatively coupled to the at least one processor. The memory stores instructions that, when executed by the at least one processor, perform operations. In some examples, these operations include receiving, from a computing device associated with an individual, a light electric vehicle use request and profile information of the individual. The location of the individual and an anticipated use of the light electric vehicle may also be determined. One or more light electric vehicles associated with the location of the individual may be identified. The identified light electric vehicles have light electric vehicle profiles that will satisfy the anticipated use of the light electric vehicle. The location of the identified light electric vehicles may then be provided to the computing device associated with the individual.

### BRIEF DESCRIPTION OF THE DRAWINGS

Non-limiting and non-exhaustive examples are described with reference to the following Figures.

FIG. 1 illustrates a light electric vehicle ridesharing system according to an example.

FIG. 2A illustrates a light electric vehicle management system according to an example.

FIG. 2B illustrates how the light electric vehicle management system of FIG. 2A can determine and provide a range offering to a light electric vehicle and/or a rider of the light electric vehicle according to an example.

FIG. 3 illustrates a method for determining a range offering for a light electric vehicle according to an example.

FIG. 4 illustrates a method for identifying light electric vehicles for various individuals having different riding experience levels according to an example.

FIG. 5 illustrates a method for providing an incentive to an individual to ride a particular light electric vehicle along a particular route according to an example.

FIG. 6 illustrates a method for determining and updating a range offering for a light electric vehicle according to an example.

FIG. 7 illustrates an example computing device according to an example.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems or devices. Accordingly, examples may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Electric ridesharing vehicles, such as electric assist bicycles and electric scooters (also referred to herein as “electric vehicles” or “light electric vehicles”), are being used by different individuals in a variety of scenarios. For example, during the week, an individual may regularly use a light electric vehicle to commute to and/or from work. However, on the weekend, the individual may use a light electric vehicle to visit friends, tour a particular location or simply go for a ride. Regardless of the intended or actual use of the light electric vehicle, it is important that the individual be notified of a determined range and/or available usage period of a particular light electric vehicle that the individual is about to reserve and ride.

Accordingly, the present disclosure describes a light electric vehicle management system that is able to determine, based on profile information associated with an individual and a location of the individual, an anticipated use and/or an anticipated route, from an origin to a destination. Using this information, the light electric vehicle management system can identify a light electric vehicle at or near the determined location of the individual that has a range offering that satisfies the requirements of the anticipated use and/or anticipated route. Thus, the individual's riding experience with a light electric vehicle may be improved because the individual may be assured that the light electric vehicle she selects will have sufficient power to get her to her desired destination.

As used, herein, the phrase “range offering” means that a light electric vehicle has sufficient power in a rechargeable battery and/or the mechanics of the light electric vehicle are in a functional state to help ensure the light electric vehicle can transport the individual to her anticipated and/or determined destination. Once the light electric vehicle is identified, the location of the light electric vehicle may be provided to a computing device associated with the requesting individual.

For example, on a Monday morning, an individual may access an application executing on her computing device and request use of a light electric vehicle. The application may identify the location of the individual and send the location information, as well as other identification information about the individual, to the light electric vehicle management system. Using the location information and the identification information, the light electric vehicle management system may identify profile information associated with the individual. The profile information of the individual may indicate that, on Monday mornings, the individual typically uses a light electric vehicle to commute from an origin at point A to a destination at point B. The profile information may also include other information about the individual, including the route (e.g., referred to as route information) the individual typically takes from point A to point B.

The profile information may also include information about how the individual typically rides or uses light electric vehicles. For example, the profile information may include the average speed of the light electric vehicle from point A to point B, the amount of power input provided by the individual (e.g., how often the individual uses pedals of the light electric vehicle versus using an electric assist motor of the light electric vehicle), a payload associated with the individual, an average number of watt hours used by the light electric vehicle along a particular route, and so on.

The route information may include directions on how to get from point A to point B. The route information may also include various pieces of information about the route itself. For example, the route information may include topology information about the route, the number of stop signs and/or stop lights along the route and so on. The topology information, stop signs, stop lights, etc., may be useful when determining a range profile for the electric vehicle. For example repeated stopping and starting due to stop signs along a route may cause the light electric vehicle to consume more power of a rechargeable battery when compared to a route that does not have as many stop signs. Likewise, riding up a hill along a route may cause the light electric vehicle to consume more power of a rechargeable battery when compared to a portion of a route that is flat.

When the anticipated use and/or anticipated route is determined, the light electric vehicle management system uses light electric vehicle profile information to automatically identify light electric vehicles near the determined location of the individual that have range offerings that will help ensure the individual will arrive at the anticipated or predicted destination. The light electric vehicle management system may then provide the location of the light electric vehicle to the computing device associated with the individual.

In some examples, the light electric vehicle management system may determine that a light electric vehicle does not have a range offering that will satisfy the anticipated use and/or anticipated route. For example, the light electric vehicle management system may determine that a particular light electric vehicle does not have a sufficient amount of power in a rechargeable battery to transport the individual from point A to point B along the anticipated route. In such examples, the light electric vehicle management system may determine a new route for the individual (e.g., a route that has fewer hills and/or fewer stop signs so the electric vehicle does not consume as much power) and provide the suggested route to the computing device associated with the individual.

In another example, the light electric vehicle management system may inform the individual that the rechargeable battery of the light electric vehicle does not have a sufficient amount of power for the anticipated use and/or anticipated route and may generate and provide request to the computing device associated with the individual. The request may be used to ask the individual to swap the rechargeable battery for a different rechargeable battery at a rechargeable battery kiosk that is located along the anticipated route (or a newly generated route or newly generated detour of an existing route) of the individual. In some examples, the individual may be provided an incentive (e.g., reduce rental rate, free ride, etc.) for stopping at the rechargeable battery kiosk to exchange rechargeable batteries.

In yet another example, the light electric vehicle management system may determine, based on profile information of the individual, that the individual requesting use of a light electric vehicle has never ridden a light electric vehicle or that the individual has only ridden a light electric vehicle a few times. In such examples, and in order to give the individual a positive first impression of light electric vehicle use, the light electric vehicle management system may use light electric vehicle profile information to determine which light electric vehicles located near the individual would potentially give the individual a positive riding experience.

Factors considered by the light electric vehicle management system may include a state of charge of a rechargeable battery of the light electric vehicle, an age of the light electric vehicle and/or the number of times the light electric vehicle has been used, a maintenance history of the light electric vehicle, a location of the light electric vehicle when compared to the location of the individual (e.g., a distance between a particular light electric vehicle and the requesting individual) and so on. Once a particular light electric vehicle has been identified, the location of the light electric vehicle may be provided to the computing device associated with the individual.

Accordingly, the present disclosure provides a number of technical benefits including, but not limited to, helping ensure that a rechargeable battery of the light electric vehicle is effectively and efficiently used thereby reducing the downtime of light electric vehicles and/or reducing a charging frequency of the rechargeable batteries, matching individual riders with particular light electric vehicles in order to give the individual a positive riding experience, and generating routes based on user profiles that maximizes power/charge usage of a rechargeable battery of a light electric vehicle, among other examples.

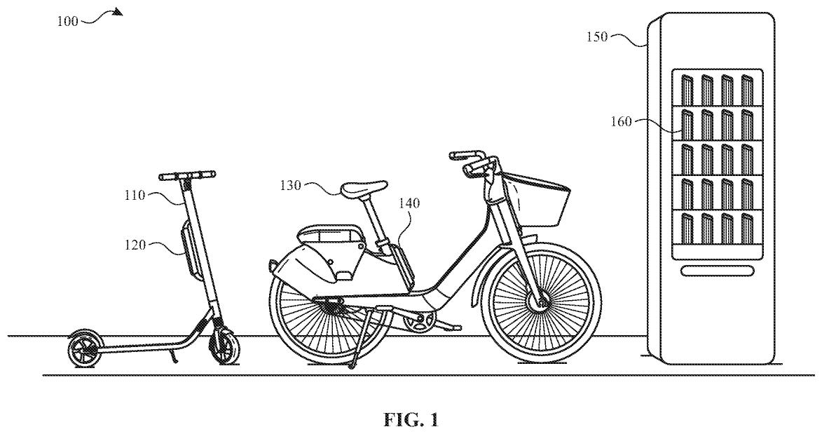

These and other features will be described in more detail below with respect to FIG. 1-FIG. 6.

FIG. 1 illustrates an example environment 100 in which aspects of the present disclosure may be practiced. As illustrated, environment 100 includes an electric scooter(s) 110, an electric bicycle(s) 130, and a rechargeable battery kiosk(s) 150. It will be appreciated that the electric scooter 110 and the electric bicycle 130 are provided as example light electric vehicles and that, in other examples, aspects described herein apply to other types of light electric vehicles.

As described herein, the environment 100 includes a network service that receives information from the electric scooter 110 and/or the electric bicycle 130 (also referred to herein as light electric vehicles) over a network communication channel (e.g., one or more networks, the Internet, etc.). The information enables a user, using a client application executing on a computing device, to locate, request, and/or reserve (e.g., rent or borrow for a duration of time) one or more light electric vehicles.

In some examples, the network service includes one or more computing systems or servers that are remote from the computing device of the user and the light electric vehicles. The one or more computing systems includes an application programming interface (API) that enables the one or more computing systems to receive information from, send information to, and otherwise interact with the computing device, the light electric vehicles 110, 130 and/or the rechargeable battery kiosk(s) 150.

For example, the client application executing on the computing device of the user receives, from the network service over the network communication channel, information about a location of one or more of the light electric vehicles. The location of each of the light electric vehicles can then be provided on a user interface of the client application.

In one example, the user interface of the client application includes a map that displays a determined location of the user and/or a determined location of the light electric vehicles. In some examples, the determined location of the user and/or the determined location of the light electric vehicles is based, at least in part, on Global Positioning System (GPS) data (or other location information) received by the network service over the network communication channel.

The user interface of the client application displays the location information of the user and the light electric vehicles as different icons (or other such representations). Once the location information is displayed, the user may select an icon representing a type of light electric vehicle (e.g., an icon for an electric scooter 110 or an icon for an electric bicycle 130). The user interface of the client application then generates or determines a route (e.g., provides directions) from the user's current location to the selected light electric vehicle. Selection of one of the icons may also enable the user to reserve (e.g., place a hold on) the light electric vehicle (to ensure that the light electric vehicle will be at the determined location when the user arrives), rent the light electric vehicle and/or borrow the light electric vehicle for a period of time.

Each light electric vehicle and/or the network service also includes a location tracking system that tracks, receives and/or determines a location of each light electric vehicle as they are used. In some examples, the location tracking system tracks the location information of the light electric vehicle in real-time or substantially real-time. In other examples, the location tracking system determines the location information of the light electric vehicle at periodic intervals (e.g., every minute, every 5 minutes, every 10 minutes, etc.). In yet other examples, the location tracking system may track the location of the light electric vehicle in real-time or substantially real-time when the light electric vehicle is rented or otherwise used by a user and may track location information at periodic intervals when the light electric vehicle has been reserved or is otherwise not is use.

The one or more computing systems of the network service also include one or more databases that store information about each of the light electric vehicles and/or the rechargeable battery kiosk(s) 150. For example, the one or more databases may store location information for each light electric vehicle and/or the rechargeable battery kiosk(s) 150, rechargeable battery status information for rechargeable batteries used by each light electric vehicle and/or in the rechargeable battery kiosk(s) 150, rechargeable battery kiosk information (e.g., the number of rechargeable batteries housed by the rechargeable battery kiosk 150), and/or light electric vehicle status information (e.g., how many times the light electric vehicle has been used, whether the light electric vehicle is damaged, whether the light electric vehicle should be serviced etc.).

The one or more databases may also store information about the user. This information may include a profile of the user (e.g., username, contact information, etc.) security credentials of the user (e.g., a password), historical usage data, payment information and the like.

The one or more computing systems of the network service may also include a matching system. The matching system receives, manages or otherwise handles various requests from the user. The requests may include light electric vehicle rental requests and light electric vehicle reservation requests. For example, when a vehicle rental request is received from the client application executing on the user's computing device, the matching system may communicate with the location tracking system and determine which light electric vehicle should be matched with or otherwise assigned to the requesting user.

The one or more computing systems of the network service may also include a payment system that processes payment information of the user. For example, when a user rents and uses a light electric vehicle, the user may be charged for the usage based on a duration of use and/or a travel distance. Once the user has finished using the light electric vehicle (e.g., by arriving at their intended destination, a check-in point, a rechargeable battery kiosk 150, etc.), the payment payment system may automatically process the payment information of the user.

As discussed above, the environment 100 includes one or more light electric vehicles including, but not limited to, an electric scooter 110 and an electric bicycle 130. In examples, the electric scooter 110 includes vehicle components (e.g., wheels, axles, baseboard, handlebar, braking mechanisms, etc.), one or more electric motors, control systems, sensors, speakers, and/or lights, which may be powered by a rechargeable battery. The rechargeable battery may be secured to the electric scooter 110 by a battery holster 120.

Likewise, and in some examples, the electric bicycle 130 includes vehicle components (e.g., wheels, axles, chains, gears, bicycle seat, handlebar, bicycle frame, braking mechanisms, etc.), one or more electric motors, control systems, sensors, speakers, and/or lights, which may also be powered by a rechargeable battery. The rechargeable battery may be secured to the electric bicycle 130 by a battery holster 140.

The control system of the electric scooter 110 and/or the electric bicycle 130 manages the power output to the one or motors, provides a visual indication as to a charge level of the rechargeable battery in the battery holster 120, and/or communicates directly (e.g., via Wi-Fi, Bluetooth, etc.) or indirectly (e.g., via one or more remote computing devices, one or more networks, the Internet, etc.) with the computing device of the user and/or with the network service.

Example communications include, but are not limited to, initiating locking or unlocking of the electric scooter 110 or the electric bicycle 130 (e.g., initiating or ending a travel session), initiating a battery swap to exchange a rechargeable battery in the battery holster 120 or the battery holster 140 with one in a rechargeable battery kiosk 150, determining a location and/or status information of the electric scooter 110 or the electric bicycle 130, and determining a location of a rechargeable battery and/or a rechargeable battery kiosk 150. Lights, speakers, and/or other output devices of the electric scooter 110 or the electric bicycle 130 may be used to provide an indication as to the location of the electric scooter 110 or the electric bicycle 130 or as an anti-theft mechanism, among other examples.

As shown in FIG. 1, each light electric vehicle includes a battery holster. For example, the battery holster 140 is affixed to the seat tube of the electric bicycle 130, while the battery holster 120 is illustrated as being affixed to the handlebar column of the electric scooter 110. It will be appreciated that the locations of the battery holsters 120 and 140 are provided as examples, and that a battery holster may be positioned in a variety of alternate locations in other examples. For example, the battery holster 140 may be affixed to the handlebar column or the cross bar of the electric bicycle 130. As another example, the battery holster 120 may be affixed to the deck or located near the rear of the electric scooter 110.

The battery holsters 120 and 140 are each operable to receive a rechargeable battery. For example, an individual user may operate a light electric vehicle for a period of time and then determine that the rechargeable battery in use by the light electric vehicle needs to be recharged. In some instances, the light electric vehicle, or the rechargeable battery itself, may communicate current battery charge information for the rechargeable battery to the computing device of the user. In another example, the rechargeable battery and/or battery holster 120 and 140 may include a visual indicator to display the charge level of the rechargeable battery. As an addition or an alternative, the electrical vehicle, or the rechargeable battery itself, may communicate current battery charge information for the rechargeable battery to the network service, which can provide battery information to the computing device of the user. When this occurs, the user may be directed to a rechargeable battery kiosk 150. For example, the network service can transmit data, over one or more networks, to the computing device to cause the computing device to display information about a particular rechargeable battery kiosk 150 to travel to.

When the user arrives at the rechargeable battery kiosk 150, the user may exchange the light electric vehicle's current battery with another rechargeable battery housed by the rechargeable battery kiosk 150, thereby enabling the light electric vehicle to continue or resume operation. In some instances, the user can use the client application executing on the computing device of the user to locate and/or select a rechargeable battery kiosk 150, receive directions to the rechargeable battery kiosk 150, and initiate a battery swap with the rechargeable battery kiosk 150 when the user arrives at its location.

According to examples, when a battery swap is initiated, the control system of the light electric vehicle may enable the rechargeable battery 160 to be removed from a battery holster, such as battery holster 120 or 140. The rechargeable battery 160 may then be exchanged for a different rechargeable battery 160 housed by the rechargeable battery kiosk 150. The rechargeable battery 160 may subsequently be inserted into the battery holster of the light electric vehicle.

The rechargeable battery kiosk 150 stores and charges a set of rechargeable batteries 160. Each rechargeable battery 160 in the set can be used by both the electric scooter 110 and the electric bicycle 130. In some examples, multiple rechargeable battery kiosks 150 are located within a city, county, or other geographic region. For example, one rechargeable battery kiosk may be located in or otherwise associated with a first geographic area within a geographic region and another rechargeable battery kiosk may be located in or otherwise associated with a second geographic area within the geographic region.

Thus, when a user is traveling through the geographic region on an light electric vehicle and wants or needs to exchange the light electric vehicle's current rechargeable battery for one that has more charge, the user may be directed (e.g., via the client application executing on the user's computing device) to the rechargeable battery kiosk 150 associated with the geographic region. When the user arrives at the rechargeable battery kiosk 150, the user can exchange their current rechargeable battery for one that is fully charged or substantially fully charged. This enables the user to travel using a light electric vehicle across distances that may otherwise not be possible using the power provided by one charge of a rechargeable battery.

In some examples, the rechargeable battery kiosk 150 comprises a control system that communicates directly or indirectly with a computing device of the user when performing a battery swap such as described above. In examples, the control system communicates with a remote computing device(s), e.g., that implements the network service, using a connection to one or more networks, such as a Wi-Fi network and/or a cellular network. The rechargeable battery kiosk 150 may receive and/or report rechargeable battery status information to a remote computing device(s). The battery status information can include, but is not limited to, battery charge levels, battery health, an amount of rechargeable batteries currently available at the rechargeable battery kiosk, and/or usage demand statistics.

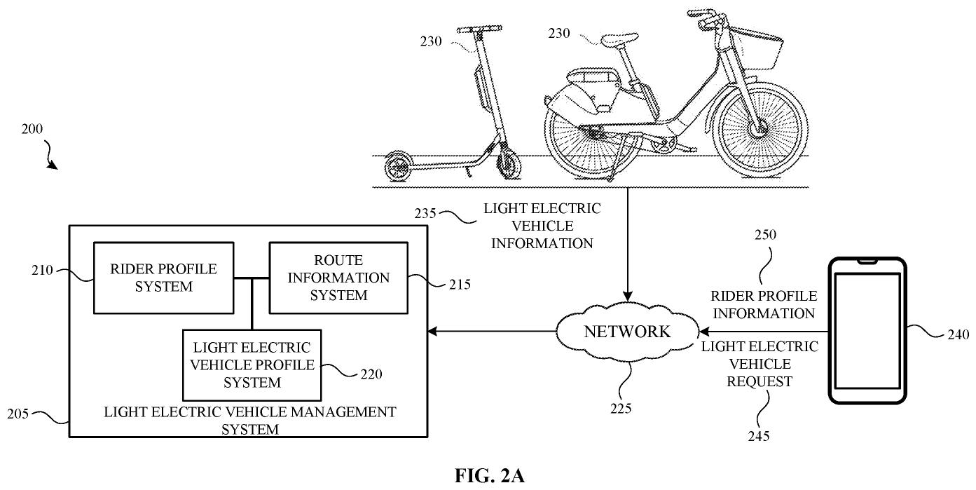

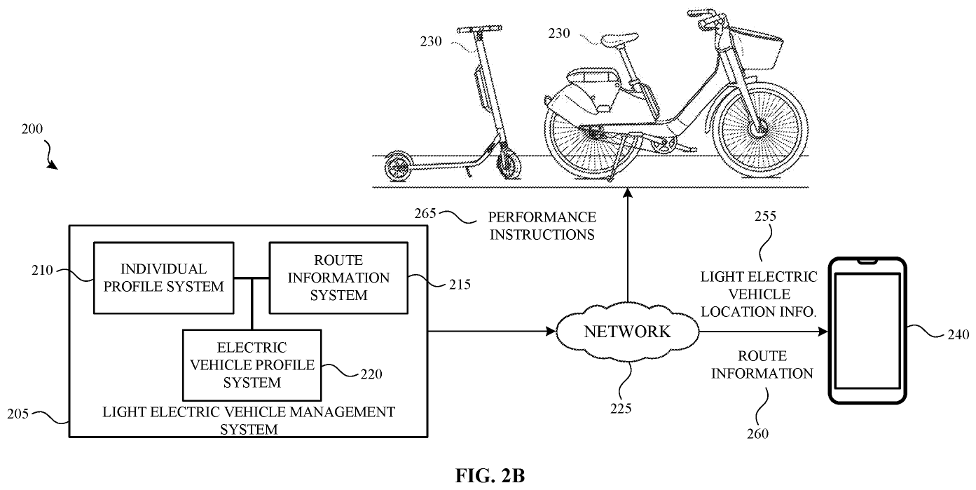

FIG. 2A illustrates a system 200 for identifying a range offering of a light electric vehicle 230 according to an example. The system 200 may be used with any number of different light electric vehicles including electric bicycles, electric scooters and so on. Additionally, the system 200 may be used to determine range offerings for light electric vehicles from any number of different manufacturers and/or third party light electric vehicle providers. In examples where a fleet of light electric vehicles includes light electric vehicles from different manufacturers and/or third party providers, the light electric vehicles may communicate with the various systems shown and described with respect to FIG. 2A and FIG. 2B using an API.

As shown in FIG. 2A, the system 200 includes a light electric vehicle management system 205. The light electric vehicle management system 205 may include a rider profile system 210, a route information system 215 and a light electric vehicle profile system 220. In order to determine a range offering for a particular light electric vehicle 230, the light electric vehicle management system 205 may receive various different types of information from various sources.

For example, and as shown in FIG. 2A, the light electric vehicle management system 205, and more particularly the light electric vehicle profile system 220 may receive light electric vehicle information 235 from a light electric vehicle 230 over a network 225. The light electric vehicle information 235 may include information about the light electric vehicle 230 that could impact the distance the light electric vehicle 230 can travel.

For example, the light electric vehicle information 235 may include information about the amount of charge or power remaining in a rechargeable battery of the light electric vehicle 230, an efficiency rating of the rechargeable battery of the light electric vehicle 230, tire pressure of one or more tires of the light electric vehicle 230, a maintenance status and/or maintenance history of the light electric vehicle 230, a model number of the light electric vehicle 230, a software version being used by the light electric vehicle 230, information about the hardware of the light electric vehicle 230, tire alignment information of the light electric vehicle 230, etc.

The light electric vehicle management system 205, and more specifically the rider profile system 210, may receive rider profile information 250 from a computing device 240 associated with the individual. The rider profile information 250 may be provided to the rider profile system 210 over the network 225. Once the rider profile information 250 is received, it may be encrypted and securely stored in the rider profile system 210.

The rider profile information 250 may contain information about the individual that wants to reserve and/or ride a light electric vehicle 230. The rider profile information 250 may include identifying information about the individual, riding habits of the individual (e.g., how fast the individual rides light electric vehicles 230, how much power from the rechargeable battery is consumed by the light electric vehicle 230 when the individual is riding the light electric vehicle 230, how often the individual uses pedals on the light electric vehicle 230, etc.), routes taken from an origin to a destination, time(s) of the day and/or day(s) of the week the individual has reserved or ridden light electric vehicles 230 in the past, the number of times the individual has reserved and/or used light electric vehicles 230, etc. Although rider profile information may be collected by the system 200, an individual may be able to opt out of such data collection and/or storage.

The rider profile information 250 may also assist the individual in reserving a light electric vehicle 230 and/or beginning a use period of the light electric vehicle 230. For example, when an individual wants to reserve and use the light electric vehicle 230, the individual may access an application executing on the computing device 240 and submit a light electric vehicle request 245, over the network 225, to the light electric vehicle management system 205. In some examples, the application executing on the computing device 240 may provide the rider profile information 250 to the rider profile system 210 of the light electric vehicle management system 205. In other examples, once the individual has been identified by the rider profile information 250, the rider profile system 210 may access the securely stored profile information of the individual in order to determine the riding habits, past routes, etc. of the requesting individual.

The light electric vehicle request 245 and/or the rider profile information 250 may also include location information associated with the individual. Once the location of the individual is determined, the light electric vehicle management system 205 may determine or identify one or more light electric vehicles 230 that are in or otherwise associated with the location of the individual.

In other examples, the individual may approach the light electric vehicle 230 on the street or sidewalk, access a light electric vehicle application on the computing device 240 and reserve the light electric vehicle 230 and/or begin a use period of the light electric vehicle 230 by scanning an identifier (e.g., a QR code) associated with the light electric vehicle 230. In such examples, the light electric vehicle request 245 and/or the rider profile information 250 may be provided to or otherwise identified by the light electric vehicle management system 205 at that time.

When the rider profile information 250 has been received or otherwise identified by the rider profile system 210, the light electric vehicle management system 205 may use this information, along with the light electric vehicle information 235 received from one or more light electric vehicles 230 and/or stored by the light electric vehicle profile system 220, to determine a range offering of one or more of the light electric vehicles 230. The range offering of each of the one or more light electric vehicles 230 may then be provided in a user interface of the computing device 240.

For example, the rider profile information 250 may include information that the individual typically reserves a light electric vehicle 230 on Monday, Wednesday and Friday mornings at 7:00 AM. The rider profile information 250 may also indicate that the individual typically reserves the light electric vehicle at or near a particular origin (e.g., near the individual's home) and travels a particular route to a particular destination (e.g., to the individual's work). Likewise, the rider profile information 250 may indicate that the individual typically reserves a light electric vehicle on Monday, Wednesday and Friday evenings at 6:00 PM and takes a particular route from an origin (e.g., the individual's work) to a destination (e.g., the individual's home).

The rider profile information 250 may be provided to the rider profile system 210 each time a light electric vehicle 230 is reserved and/or used by the individual. In other examples the rider profile system 210 may use sign-in credentials received from the computing device 240 and associated with the individual to access rider profile information 250 that has been securely stored in the rider profile system 210. The stored rider profile information 250 may be updated as new or additional information (e.g., additional routes taken by the individual, changes or updates in riding habits) is received from the computing device 240 and/or the light electric vehicle 230.

Although the above example indicates that route and other information is received from a computing device 240, in some instances, the rider profile system 210 may receive route information, reservation information and/or origin/destination information of the individual from the light electric vehicle 230. For example, the light electric vehicle 230 may provide GPS data or other location information to the light electric vehicle management system 205. The light electric vehicle management system 205 may store the received information in the rider profile system 210 associated with the individual that reserved and is riding the light electric vehicle 230.

The light electric vehicle management system 205 may use the rider profile information 250 to accurately predict, determine and/or anticipate a route of travel of the individual. In some examples, this includes determining or anticipating different topographies and traffic signals and/or traffic signs along a route or an anticipated route that could potentially cause the light electric vehicle to consume additional power in a rechargeable battery. For example, if the individual reserves the light electric vehicle 230 at 7:00 AM on Monday morning, the light electric vehicle management system 205 may determine, based on the rider profile information 250, that the individual is going to work. The light electric vehicle management system 205 may also determine, using the rider profile information 250, that the individual will most likely take a particular route on the way to work and that this particular route includes two hills, four stop signs and five stop lights. Using this information, the light electric vehicle management system 205 may be able to determine a range offering for the light electric vehicle 230. For example, the light electric vehicle management system 205 may determine the amount of watt hours consumed by the light electric vehicle 230 when the light electric vehicle travels up the hills and stops and starts at the stop signs or stop lights.

As discussed above, the rider profile information 250 may also include riding habits of the individual. The riding habits may be general riding habits of the individual or may be riding habits of the individual along the particular route. For example, the riding habit information may indicate that light electric vehicles 230 ridden by the individual along a particular route of five miles, typically consume one hundred watt hours of power of the rechargeable battery. Thus, when this particular individual rides light electric vehicles 230 along a particular route, the light electric vehicle 230 typically consumes twenty watt hours per mile.

In another example, the rider profile information 250 may include information about a pedaling cadence of the individual, typical riding speeds of the individual, a pedaling frequency of the individual, how often and when the individual relies on an electric assist motor of the light electric vehicle 230, gear shifting habits of the individual (e.g., how often, when and where along a route the individual shifts gears), etc.

Using this information, the light electric vehicle management system 205 may determine a range offering of each light electric vehicle 230 in or around the location of the individual. The range offering may then be used to identify which light electric vehicle 230 the individual should select.

For example and referring to FIG. 2B, once the range offering of each light electric vehicle 230 in or around the location of the individual is identified by the light electric vehicle management system 205, the light electric vehicle management system 205 may provide light electric vehicle location information 255 to the computing device 240 associated with the individual. The light electric vehicle location information 255 may identify light electric vehicles 230 in or around the determined location of the individual. In other examples, the light electric vehicle location information 255 may only identify light electric vehicles 230 that have a range offering that help ensure the individual will be able to make it to the anticipated destination.

For example and referring back to FIG. 2A, an individual may submit, via the computing device 240, a light electric vehicle request 245. Upon receiving the light electric vehicle request 245, the light electric vehicle management system 205 determines, using rider profile information 250, that it is anticipated the individual is travelling five miles to work. The light electric vehicle management system 205 may also determine that, based on riding habits of the individual, the individual typically causes the light electric vehicle 230 to consume 100 watt hours of power from the rechargeable battery.

Based on this information, the light electric vehicle management system may identify (using received or stored light electric vehicle information 235) which light electric vehicles 230 have a sufficient amount of power in a rechargeable battery to enable the individual to travel to her anticipated or predicted destination.

In some examples, the range offering of the identified light electric vehicle may include a minimum range offering threshold or range threshold that would be required to help ensure the individual makes it to the determined destination along the anticipated route. Thus, light electric vehicles 230 with a greater range offering may be reserved for individuals that typically take longer routes or cause the light electric vehicle 230 to consume more power. Likewise, light electric vehicles 230 with greater range offerings may be reserved for individuals that are new users of the system 200. Since these individuals are new or newer to the system 200, the light electric vehicle management system 205 may not have sufficient data to enable the light electric vehicle management system 205 to accurately predict routes, riding habits, etc.

For example, if the light electric vehicle management system 205 determines that a light electric vehicle 230 ridden by a first individual will likely consume fifty watt hours along an anticipated route or to an anticipated destination (or to an actual destination selected or provided by the individual), the light electric vehicle management system may identify only those light electric vehicles 230 that have range offerings within a particular range or between range offering thresholds (e.g., light electric vehicles that have range offerings between fifty watt hours and sixty watt hours or higher). However, if a second individual is accessing the system 200 for the first time, the light electric vehicle management system 205 may identify light electric vehicles that have large range offerings (e.g., light electric vehicles 230 having a rechargeable battery state of charge above a threshold, such as, for example eighty percent or higher). Likewise, if a third individual is reserving a light electric vehicle 230 and the light electric vehicle management system determines, based on profile information associated with the third individual, that the third individual typically consumes eighty watt hours along the anticipated route, the light electric vehicle management system 205 may identify light electric vehicles 230 that have range offerings within a second particular range or between a second range offering thresholds (e.g., light electric vehicles that have range offerings between eight-five and one hundred watt hours or higher).

The location of the identified light electric vehicles 230 (e.g., light electric vehicle location information 255 (FIG. 2B)) may then be provided to the computing device 240 associated with the individual. In some examples, the light electric vehicle location information 255 may also include a notification stating that the identified light electric vehicles 230 have sufficient power to enable the individual to arrive at their predicted destination along their anticipated route. Thus, individuals may be encouraged to use light electric vehicles with lower range offerings instead of simply selecting a light electric vehicle with the highest state of charge in a rechargeable battery.

In some examples, the individual may use the computing device 240 to select or otherwise input a destination. As with other examples described herein, the light electric vehicle management system 205 may identify light electric vehicles 230 that have range offerings that will enable the individual to reach the selected destination.

In situations in which the desired destination is known or the anticipated destination is determined and/or is above a certainty threshold (e.g., the individual has taken the same or similar route four out of the last five Mondays at 7:00 AM from an origin to a destination), the light electric vehicle management system 205 may select or otherwise identify a light electric vehicle 230 that needs to be serviced and/or has a rechargeable battery that should be exchanged with a different rechargeable battery in a rechargeable battery kiosk (e.g., rechargeable battery kiosk(s) 150 (FIG. 1)). The location of the light electric vehicle may then be provided to the computing device 240 associated with the individual. In some examples, if the individual agrees to use the light electric vehicle 230 and take a specified action (e.g., exchange rechargeable batteries), the individual may be provided with an incentive (e.g., reduced rate for riding the identified light electric vehicle 230, discount on a future ride, etc.).

In examples where an individual walks up to a light electric vehicle 230 on the sidewalk or street and tries to reserve or begin a use period at that time (verses using an application executing on the computing device 240 to identify the locations of one or more light electric vehicles 230), the light electric vehicle management system 205 may determine a range offering for that particular light electric vehicle 230. The light electric vehicle management system 205 may provide a notification as to whether the light electric vehicle 230 selected by the individual has a sufficient amount of power in a rechargeable battery to enable the individual to arrive at the individual's predicted (or selected) destination.

During the course of a ride, the light electric vehicle management system 205 may continuously or periodically receive light electric vehicle information 235 from the light electric vehicle 230 being ridden by the individual. As this information is received, the light electric vehicle management system 205 may update the range offering of the light electric vehicle 230 in real-time or substantially real-time. In some examples, the updated range offering may be provided to the computing device 240 of the individual.

As shown in FIG. 2B, the light electric vehicle management system 205 may also provide one or more performance instructions 265 to the light electric vehicle 230 while the light electric vehicle 230 is being ridden by the individual. The performance instructions 265 may be used to change, limit or restrict certain functionality parameters of the light electric vehicle 230 to help ensure the range offering is achievable. For example, if the light electric vehicle management system 205 determines during the course of a ride that the light electric vehicle 230 on which the individual is riding is consuming more battery power than was predicted (e.g., because the individual is travelling faster than anticipated, an anticipated payload associated with the individual is different than anticipated based on previously determined payload information, the efficiency of the rechargeable battery has decreased, the individual is taking a different route), the light electric vehicle management system 205 may send performance instructions 265 to the light electric vehicle 230 to limit a top speed of the light electric vehicle 230. The light electric vehicle management system 205 may also provide a notification to the computing device 240 of the individual notifying her of the change in performance and/or the determined reason the functionality parameters were changed.

In some examples, the performance instructions 265 may be configured to alter one or more functionality parameters of the light electric vehicle 230 over time. For example, a first set of performance instructions 265 may change the top speed of the light electric vehicle 230 from fifteen miles-per-hour to twelve miles-per-hour in order to increase the range offering. However, if the light electric vehicle management system 205 determines, based on information (e.g., light electric vehicle information, riding habits of the individual and/or information on how the individual is currently riding the light electric vehicle 230) received in real-time or substantially real-time, that the available range of the light electric vehicle 230 needs to be altered, the light electric vehicle management system 205 may send another performance instruction 265 to the light electric vehicle 230 that changes the top speed from twelve miles-per-hour to ten miles-per-hour.

FIG. 2B also illustrates that the light electric vehicle management system 205 may provide route information 260 to the computing device 240 associated with the individual. In other examples, the light electric vehicle management system 205 may provide route information 260 directly to the light electric vehicle 230. The route information 260 may be output on a display associated with the light electric vehicle 230. The light electric vehicle 230 may also provide one or more visual notifications, audio notifications and/or haptic notifications that prompt an individual to turn down various roads or streets along the route.

In some examples, the route information 260 may specify a route that conserves power or otherwise increases a range offering of a rechargeable battery of the light electric vehicle 230. For example, the light electric vehicle management system 205 may determine that a predicted route of the individual has two hills and seven stop signs. The light electric vehicle management system 205 may also determine that the individual typically relies heavily on the electric assist motor of the light electric vehicle 230 when ascending the hill and when starting the light electric vehicle 230 after stopping at the stop signs. These riding habits of the individual may cause the light electric vehicle 230 to consume a lot of power of the rechargeable battery.

In order to conserve power in the rechargeable battery and increase the range offering, the route information system 215 may generate a route that avoids the one or more hills along the route and/or avoids the stop signs along the anticipated route. The generated route (shown as route information 260) may be provided to the computing device 240 of the individual. In some examples, the generated route may be longer in distance but the power consumed by the increased distance may be less than the power consumed by travelling up the hill and/or continuously starting and stopping the light electric vehicle 230 at each of the stop signs.

In yet another example, the light electric vehicle management system 205 may identify light electric vehicles 230 that the individual can use or reserve even when a range offering is not sufficient to get the individual to their predicted destination. In such examples, the route information system 215 may generate or suggest a route that causes the individual to ride by a rechargeable battery kiosk. The individual can stop at the rechargeable battery kiosk and exchange the current rechargeable battery in the light electric vehicle for a different rechargeable battery in the rechargeable battery kiosk. The individual may then continue to her destination.

In some examples, the light electric vehicle management system 205 may also determine a route for the individual based on the range offering of a light electric vehicle 230 and the other received information (e.g., light electric vehicle information 235 and/or rider profile information 250). For example, if the light electric vehicle management system 205 determines that the state of charge of the rechargeable battery of the light electric vehicle 230 is below a range offering threshold, the light electric vehicle management system 205 may determine a location of a rechargeable battery kiosk (e.g., rechargeable battery kiosk(s) 150 (FIG. 1)) along or near an anticipated (or known) route or an anticipated (or known) destination of the individual. The light electric vehicle management system 205 may then generate a route that causes the individual to pass the rechargeable battery kiosk and provide that route to the computing device 240.

In some examples, the individual may be notified of the generated route and may be provided with an incentive to use that route and take a specified action such as, for example, exchange the rechargeable battery of the light electric vehicle 230 with one contained in the rechargeable battery kiosk. In such examples, the light electric vehicle management system 205 may track the operating parameters and/or location of the light electric vehicle 230 to ensure the individual is following the parameters set forth in the incentive.

Referring back to FIG. 2A, in some examples, the rider profile information 250 may indicate that the individual has never ridden a light electric vehicle 230 or that the individual has ridden light electric vehicles 230 under a threshold amount of times (e.g., ten). In such examples, the light electric vehicle management system 205 may use the light electric vehicle information 235 to identify one or more light electric vehicles 230 that would potentially give the individual the best riding experience. For example, the light electric vehicle management system 205 may identify light electric vehicles 230 that have the largest range offering, light electric vehicles 230 that are closest to or within a threshold distance from a location of the individual, light electric vehicles 230 that are newer (e.g., new models) when compared to other light electric vehicles 230, light electric vehicles 230 whose maintenance histories indicate that it has been recently serviced, light electric vehicles from a particular manufacturer, light electric vehicles that have a particular hardware or software profile, etc. Once the light electric vehicles 230 are identified, the light electric vehicle management system 205 may provide light electric vehicle location information 255 (FIG. 2B) to the computing device 240 associated with the individual such as previously described.

In some examples and in order to help the requesting individual identify the light electric vehicle 230 she have reserved, the light electric vehicle management system 205 may send instructions to the light electric vehicle 230 to provide or output a visual indication or notification to help the individual identify the light electric vehicle 230 she has reserved. This may include instructions to activate one or more lights on the light electric vehicle 230. For example, if an individual has reserved a light electric vehicle for the first time (or under a threshold amount of times) the light electric vehicle may activate a light, or series of lights, in a particular pattern or in a particular color to let the individual know she has reserved that particular light electric vehicle 230. In another example, if a light electric vehicle is on the street or sidewalk and is available for reservation or use, the light electric vehicle management system 205 may instruct the light electric vehicle 230 to provide a visual availability notification. The availability notification may be a light, a series of lights, blinking lights arranged in a pattern and so on.

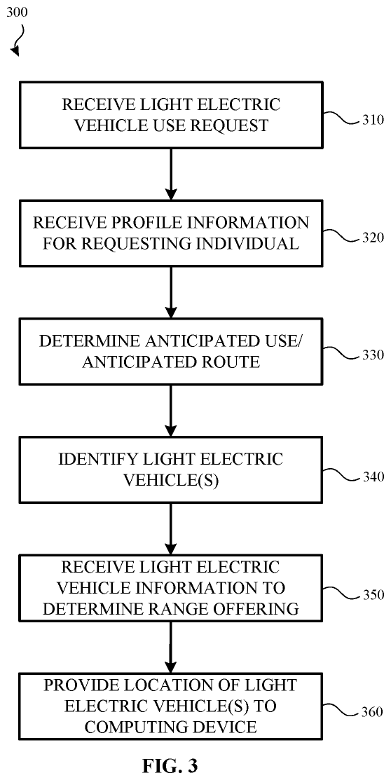

FIG. 3 illustrates a method 300 for identifying a light electric vehicle that has a sufficient range offering for a predicted route and/or predicted use according to an example. The method 300 may be performed by one or more of the systems shown and described with respect to FIG. 2A and FIG. 2B.

Method 300 begins when a light electric vehicle use request is received (310) by a system, such as, for example a light electric vehicle management system. In some examples, the use request is provided by an application executing on a computing device associated with an individual that wants to reserve and use a particular light electric vehicle.

The light electric vehicle management system may also receive (320) or otherwise determine profile information about the requesting individual. In some examples, the profile information may include identification information about the individual, riding habits of the individual, past routes including the origin and the destinations of those routes, time(s) of day and/or day(s) of the week the individual has ridden light electric vehicles, a riding experience level of the individual, etc.

In some examples, the information about the individual may be included or otherwise associated with the light electric vehicle use request. In other examples, the profile information received as part of the use request or identified in the use request may allow the light electric vehicle management system to identify previously received and stored profile information of the requesting individual. In yet other examples, riding habits and other profile information (e.g., route information, time(s) of the day the individual reserves or uses light electric vehicles) of the individual may be received by the system in real-time or substantially real-time from the light electric vehicle as the individual is riding the light electric vehicle and/or from a computing device associated with the individual.

This information may be used to build a rider profile for the individual. The rider profile may include information about how the individual likes to ride the light electric vehicle and may include information about how often and when the individual switches gears, typical riding speeds of the individual, a pedaling cadence of the individual, a pedaling frequency of the individual, an amount of charge of a rechargeable battery of the light electric vehicle consumed by the light electric vehicle as the individual rides the light electric vehicle, how often and when the individual uses an electric assist motor of the light electric vehicle, etc.

Once this information is received, the light electric vehicle management system may determine (330) an anticipated route and/or an anticipated use for the light electric vehicle. For example, if the individual is reserving a light electric vehicle on Monday at 7:00 AM, the light electric vehicle management system may predict the individual is going to work. Based on this prediction, the light electric vehicle management system may predict the route the individual will use to get from their current location to the predicted destination.

In another example, if the individual reserves a light electric vehicle on a Saturday at 12:00 PM, the light electric vehicle management system may determine the individual is getting some exercise, going to see a friend, touring the city etc. If the individual has not or does not typically reserve and use light electric vehicles on the weekend, the light electric vehicle management system may not be able to predict a route, but may use this information to update the profile of the individual and subsequently use this information to determine anticipated uses or routes for other weekend (or week day) reservations.

The light electric vehicle management system may also determine a location of the individual. The location information may be based on GPS data or other location-based data received from a computing device associated with the individual. The location information of the individual may be included or otherwise associated with the use request. The location information of the individual may also be used to identify (340) one or more light electric vehicles in an area associated with the location of the individual. In some examples, the location of the one or more light electric vehicles is received by the light electric vehicle management system. Thus, when the light electric vehicle management system receives or determines the location of the individual, the light electric vehicle management system may also determine which light electric vehicles are at or near the location of the individual. The location of the identified light electric vehicles may be provided on a user interface of the individual's computing device. The individual may then select and/or reserve one of the identified light electric vehicles.

In other examples, the individual may approach a light electric vehicle on the sidewalk or street, access a light electric vehicle application on the computing device and reserve the light electric vehicle by scanning an identifier (e.g., a QR code) associated with the light electric vehicle. In such examples, the use request, profile information and riding habits of the individual may be provided to or identified by the light electric vehicle management system at that time.

The light electric vehicle management system may also receive (350) or otherwise determine light electric vehicle information for the identified light electric vehicles associated with the location of the individual to determine a range offering of each of the identified light electric vehicles. In some examples, this information may include a current state of charge of a rechargeable battery of the light electric vehicle, a maintenance history of the light electric vehicle, an efficiency rating of the light electric vehicle and so on. The light electric vehicle information may be used in combination with the information about the individual to determine a range offering for each of the identified light electric vehicles. For example, if the riding habits of the individual indicate that the individual typically relies heavily on the electric assist motor when riding the light electric vehicle, the range offering for a particular light electric vehicle may be different when compared to an individual that prefers to pedal.

Once the range offering for each light electric vehicle is determined, the light electric vehicle management system may identify which light electric vehicles have a range offering that can satisfy the anticipated use and/or anticipated route and provide (360) the location of the identified light electric vehicles to the computing device of the individual. In some examples, the individual may be prompted or otherwise directed to a light electric vehicle that has a minimum range offering (or a range offering within a range of range offerings, such as, for example range offerings between three miles and five miles) that can satisfy the anticipated use.

In some examples, the range offering may change over the course of a ride or route. For example, if the individual deviates from a predicted route or changes her riding habits, the range offering may be adjusted in real-time or substantially real-time. In some examples, the updated range offering may then be provided to the computing device associated with the individual. The updated range offering may include a notification that the individual will not reach their selected or determined destination. The notification may also include a location of one or more rechargeable battery kiosks that may be used to exchange the current rechargeable battery with a different rechargeable battery. The notification may also include an alternate route that may increase the range offering of the light electric vehicle. In yet another example, one or more operating parameters of the light electric vehicle (e.g., a top speed) may be altered in order to increase the range offering.

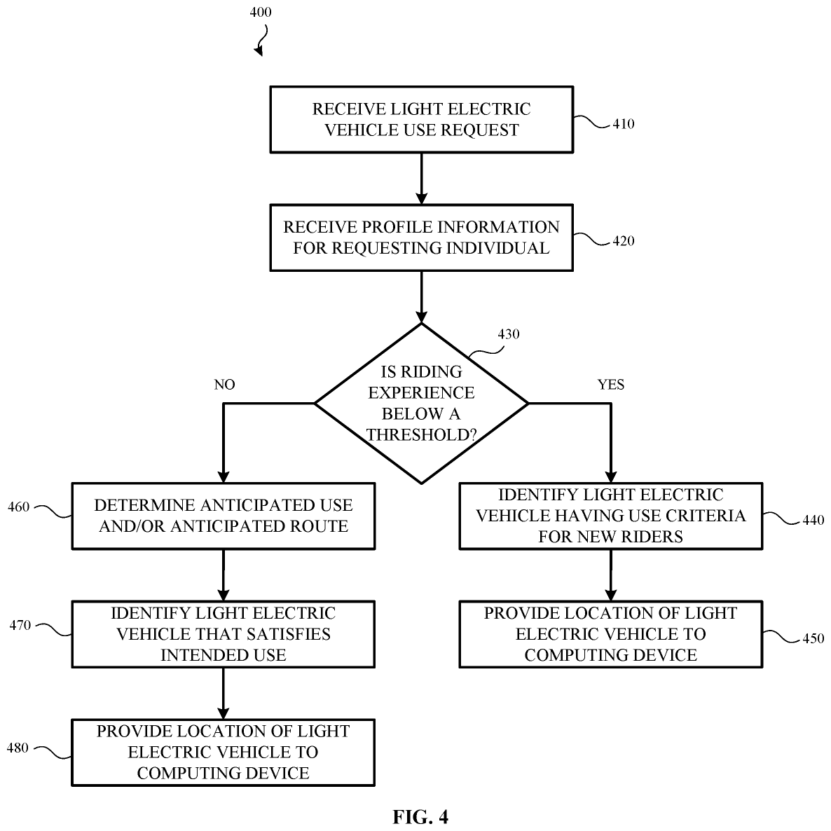

FIG. 4 illustrates a method 400 for identifying light electric vehicles for various individuals having different riding experiences according to an example. The method 400 may be performed by one or more of the systems shown and described with respect to FIG. 2A and FIG. 2B.

Method 400 begins when a system, such as, for example, a light electric vehicle management system, receives (410) a light electric vehicle use request. The light electric vehicle use request may be received such as was previously described herein. When the light electric vehicle use request is received, the light electric vehicle management system receives (420) or otherwise determines profile information associated with requesting individual. The profile information may include a light electric vehicle experience level of the individual, riding habits of the requesting individual, past routes taken by the individual, etc.

The light electric vehicle management system may determine (430) whether the riding experience of the requesting individual is below a light electric vehicle riding experience threshold. If the experience level of the requesting individual is below the threshold, the light electric vehicle management system identifies (440) light electric vehicles in or around the determined location of the requesting individual. For example, it may be important to an owner or operator of light electric vehicles that the individual has the best riding experience possible so the individual will reserve and ride light electric vehicles in the future. As such, the light electric vehicles that are identified are light electric vehicles that have or are otherwise associated with use criteria for new riders.

The use criteria may include one or more of: having a location that is within a maximum distance from a location of the requesting individual, having a rechargeable battery state of charge above a charge threshold (e.g., eighty percent), a particular model number or model numbers, a particular hardware and/or software profile, a maintenance history indicating the light electric vehicle was serviced within a time threshold, and/or other information that indicates whether the light electric vehicle is operating as expected.

Once the light electric vehicles having the use criteria are identified, the light electric vehicle management system provides (450) the location of the identified light electric vehicles to the computing device associated with the individual. The individual may then select one of the identified light electric vehicles to reserve and/or use.

However, if it is determined (430), using profile information associated with the requesting individual, that the light electric vehicle riding experience of the requesting individual is above a threshold, the light electric vehicle management system may determine (460) an anticipated use and/or an anticipated route of the individual. The anticipated use and/or route may be based on information contained in the light electric vehicle use request and/or the profile information of the requesting individual.

For example, the light electric vehicle use request may contain profile information associated with the individual. The profile information may include information about typical starting locations of the individual, typical payloads associated with the individual, how efficiently the individual operates the light electric vehicle, typical ending locations of the individual and one or more routes the individual typically takes between those starting locations and ending locations. The anticipated route and/or anticipated use may also be based on time(s) of the day and/or day(s) of the week the individual submitted the use request.

Once the anticipated use and/or anticipated route has been determined, the light electric vehicle management system may identify (470) one or more light electric vehicles in or otherwise associated with the determined location of the individual that have range offerings that can satisfy the anticipated route and/or anticipated use. In some examples, the identified light electric vehicles have minimum threshold range offerings that will satisfy the anticipated use. For example, if the anticipated use of the light electric vehicle is a five mile ride that typically consumes forty watt hours, light electric vehicles having a range offering of seven miles and/or fifty watt hours will be identified and their locations provided to the individual. When the light electric vehicles having sufficient ranges offerings are identified, the locations of the light electric vehicles are provided to the computing device associated with the individual.

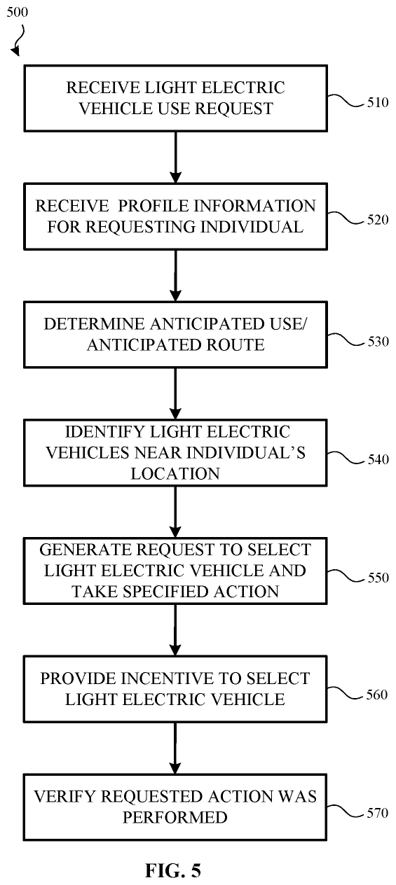

FIG. 5 illustrates a method 500 for providing an incentive for an individual to ride a particular light electric vehicle along a particular route according to an example. The method 500 may be performed by one or more of the systems shown and described with respect to FIG. 2A and FIG. 2B.

As with the other methods described herein, method 500 begins when the light electric vehicle management system receives (510) a light electric vehicle use request from a computing device associated with an individual. The light electric vehicle management system may also receive (520) or otherwise identify profile information for the requesting individual. The profile information may be used to determine (530) an anticipated route and/or an anticipated use for the light electric vehicle such as was previously described.

The light electric vehicle management system may also receive (540) or otherwise identify information about light electric vehicles in or otherwise associated with the location of the individual. The information may include a length of time the light electric vehicle has been idle, the state of charge of a rechargeable battery of the light electric vehicle, a distance the light electric vehicle is from a rechargeable battery kiosk, a range offering of the light electric vehicle, etc.

In some examples, it may be desirable to have the individual ride a particular light electric vehicle to another location even if, for example, the light electric vehicle does not have a range offering that will allow the individual to reach their predicted or a selected destination. For example, if a particular light electric vehicle has not been used for two days and/or the remaining amount of power in a rechargeable battery of the light electric vehicle is below a threshold (e.g., twenty percent), the light electric vehicle management system may generate (550) a request that the individual select that particular light electric vehicle and take a specified action (e.g., exchange the current rechargeable battery of the light electric vehicle with a new rechargeable battery in a rechargeable battery kiosk).

In some examples, the generated request may be provided to the individual based on the anticipated route and/or anticipated use of the individual. For example, if the rechargeable battery of the light electric vehicle is below a threshold (e.g., twenty percent) and the anticipated route of the individual either includes or is within a threshold distance (e.g., two blocks, half a mile, quarter of a mile, etc.) from a location of a rechargeable battery kiosk, the light electric vehicle management system may generate a notification that requests the individual to ride the particular light electric vehicle to or past a particular destination and perform the specified action (e.g., swap the current rechargeable battery with a rechargeable battery from the rechargeable battery kiosk).

In some examples, the light electric vehicle management system may provide (560) an incentive (e.g., reduce rental rate, free ride, etc.) to the individual in exchange for the individual taking the requested action. As part of the requested action, the light electric vehicle management system may be configured to specify a particular route for the individual in order to assist the individual taking the requested action.

The light electric vehicle management system may track the operating parameters and/or location of the light electric vehicle to verify (570) the individual is following the parameters set forth in the incentive. For example, the light electric vehicle management system may track or otherwise determine the location of the light electric vehicle to determine whether the individual is following the specified route and/or whether the light electric vehicle has reached a rechargeable battery kiosk or other requested location. The light electric vehicle management system may also receive light electric vehicle information to determine whether the requested action was performed. For example, the light electric vehicle management system may receive information regarding whether the current rechargeable battery of the light electric vehicle was replaced with a different rechargeable battery from the rechargeable battery kiosk (e.g., by receiving an identifier associated with the rechargeable battery, receiving current rechargeable battery power information, etc.).

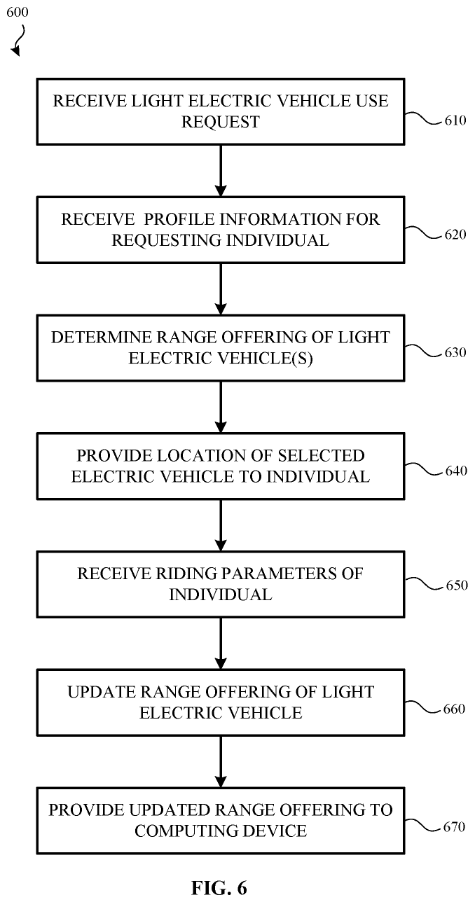

FIG. 6 illustrates a method 600 for determining and updating a range offering for a light electric vehicle according to an example. The method 600 may be performed by one or more of the systems shown and described with respect to FIG. 2A and FIG. 2B.

Method 600 begins when a light electric vehicle use request is received (610). Using the information contained in the light electric vehicle use request, the light electric vehicle management system may determine or otherwise receive (620) profile information associated with the requesting individual. The profile information may allow the light electric vehicle management system to determine an anticipated route and/or an anticipated use of the light electric vehicle such as previously described.

The light electric vehicle management system may also receive or otherwise determine light electric vehicle information for one or more light electric vehicles in a location associated with the requesting individual. The light electric vehicle information may include rechargeable battery information such as, an amount of charge remaining in the rechargeable battery and/or a battery efficiency rating of the electric vehicle. Although rechargeable battery information is specifically mentioned, the light electric vehicle management system may receive various kinds of operating parameter information from the light electric vehicle including maintenance history information, tire pressure information, tire alignment information or any other information that could impact a range offering of the light electric vehicle.

The light electric vehicle management system may then determine (630), based on a combination of some or all of the received information, a range offering for one or more of the light electric vehicles. For example, the light electric vehicle management system may determine whether the light electric vehicle can or should travel the entire distance of the anticipated route (or to a destination selected or otherwise specified by the individual).

For example, if the rechargeable battery information indicates that the rechargeable battery is below a charge threshold and/or the riding habits of the individual indicate that the light electric vehicle will not have enough battery power to run an electric assist motor of the light electric vehicle along the entire anticipated route (e.g., because the route has hills and/or the individual does not pedal very often and primarily relies on the electric assist motor), the light electric vehicle management system may determine that this particular light electric vehicle should not be identified or otherwise made available to the requesting individual. However, if the light electric vehicle management system determines that another light electric vehicle has a sufficient amount of charge in the rechargeable battery and/or the efficiency of the rechargeable battery will allow the individual to ride the entire distance along the anticipated route using the same or similar riding habits that the individual previously used, that light electric vehicle may be identified and the location may be provided (640) to the computing device of the individual.

Once a light electric vehicle is selected by the individual, the light electric vehicle management system may receive (650) riding parameters associated with the individual. The riding parameters may include information that may positively or negatively impact the determined range offering. For example, if the light electric vehicle management system determined the range offering based on an anticipated route, but the light electric vehicle management system determines, based on received location information of the light electric vehicle, that the individual is deviating from the anticipated route or is taking an entirely different route, the light electric vehicle management system may use the information to update the prediction of the route. The range offering along the newly predicted route may also be updated. For example, the light electric vehicle management system may use previously received information about a particular portion of a route (e.g., street, highway, freeway), including topography information, traffic signals, etc., to determine what features along this route could negatively or positively impact the range offering.

In another example, the riding parameters may include a determination of a payload associated with the individual. For example, the light electric vehicle management system may determine, based on distance traveled, watt hours consumed by the light electric vehicle and the topography of a route, a payload associated with the individual. However, if the light electric vehicle management system receives information that the payload has changed (e.g., due to two individuals riding a single light electric vehicle), the light electric vehicle management system may use this information to update the range offering.

In yet another example, the riding parameters of the individual may indicate that the individual is pedaling a light electric vehicle more often. In other examples, the riding parameters of the individual may indicate that the individual is stopping more frequently, less frequently, causing the light electric vehicle to consume more/less power from the rechargeable battery and so on. In each of these examples, the light electric vehicle management system may use this information to update (660) a range offering of the light electric vehicle. The updated range offering may then be provided (670) to the computing device associated with the individual.

In some examples, when the updated range offering is provided, the light electric vehicle management system may determine or otherwise generate a suggested route to increase the range offering. The generated route may be provided to the computing device associated with the individual.

The generated route may be a route that may enhance the range offering of the rechargeable battery of the light electric vehicle. For example, the generated route may avoid hills on which the individual typically rides. In other examples, the generated route may be a route that takes the individual to a rechargeable battery kiosk, another light electric vehicle (e.g., one with more power in the rechargeable battery) or a maintenance facility. When the individual arrives at the rechargeable battery kiosk or maintenance facility, the individual may use the rechargeable battery kiosk to swap rechargeable batteries or may exchange the current light electric vehicle for another at a maintenance facility.

As discussed above, in some examples, an incentive for taking the generated route may be provided to the computing device of the individual. The individual may choose to accept the generated route and the incentive. However, if the individual does not want to take the generated route, the individual may be notified that the selected light electric vehicle may not have enough power to get the individual to their anticipated destination based on the anticipated route and known riding habits. As such, the light electric vehicle management system may direct the individual to another light electric vehicle.

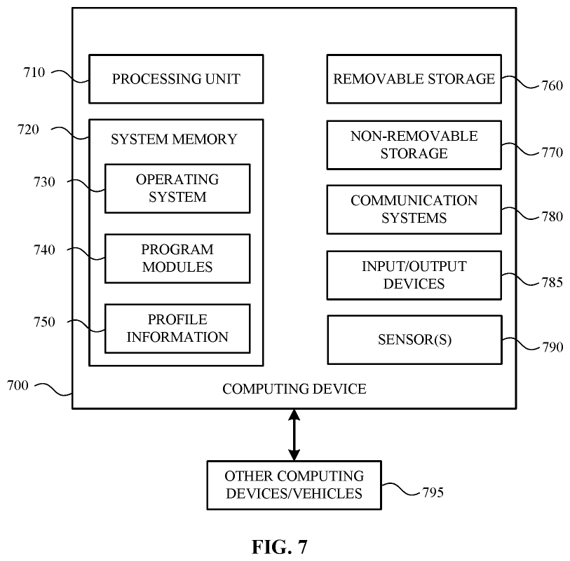

FIG. 7 is a system diagram of a computing device 700 according to an example. The computing device 700 may be integrated with or associated with a light electric vehicle, such as light electric vehicle 230 shown and described with respect to FIG. 2A and FIG. 2B. The computing device 700 may also be associated or otherwise integrated with the various systems shown and described with respect to FIG. 1, FIG. 2A and FIG. 2B. As shown in FIG. 7, the physical components (e.g., hardware) of the computing are illustrated and these physical components may be used to practice the various aspects of the present disclosure.

The computing device 700 may include at least one processing unit 710 and a system memory 720. The system memory 720 may include, but is not limited to, volatile storage (e.g., random access memory), non-volatile storage (e.g., read-only memory), flash memory, or any combination of such memories. The system memory 720 may also include an operating system 730 that controls the operation of the computing device 700 and one or more program modules 740. While executing on the processing unit 710, the program modules 740 may perform the various processes described above. For example, the program modules 740 may be responsible for gathering or determining rider profile information, light electric vehicle information, riding habit information and so on. The system memory 720 may also store this information (represented as profile information 750) or otherwise provide access to this information.

The computing device 700 may also have additional features or functionality. For example, the computing device 700 may include additional data storage devices (e.g., removable and/or non-removable storage devices) such as, for example, magnetic disks, optical disks, or tape. These additional storage devices are labeled as a removable storage 760 and a non-removable storage 770.

Furthermore, examples of the disclosure may be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 7 may be integrated onto a single integrated circuit. Such a SOC device may include one or more processing units, graphics units, communications units, system virtualization units and various application functionality all of which are integrated (or “burned”) onto the chip substrate as a single integrated circuit.

When operating via a SOC, the functionality, described herein, may be operated via application-specific logic integrated with other components of the computing device 700 on the single integrated circuit (chip). The disclosure may also be practiced using other technologies capable of performing logical operations such as, for example, AND, OR, and NOT, including but not limited to mechanical, optical, fluidic, and quantum technologies. In addition, examples of the disclosure may be practiced using a computing device associated with or integrated with a light electric vehicle and/or in any other circuits or systems.

The computing device 700 may include one or more communication systems 780 that enable the electric vehicle to communicate with rechargeable batteries, other computing devices/vehicles 795 (e.g., remote computing devices, other light electric vehicles), a network service and the like. Examples of communication systems 780 include, but are not limited to, radio frequency (RF) transmitter, receiver, and/or transceiver circuitry, a Controller Area Network (CAN) bus, a universal serial bus (USB), parallel, and/or serial ports.

The computing device 700 may also have one or more input devices and/or one or more output devices shown as input/output devices 785. These input/output devices 785 may include a keyboard, a sound or voice input device, a touch, force and/or swipe input device, a display, speakers, etc. The aforementioned devices are examples and others may be used.

The computing device 700 may also include one or more sensors 790. The sensors 790 may be used to detect or otherwise provide information about the operating condition of the light electric vehicle. In other examples, the sensors 790 may provide information about a light electric vehicle to which the computing device 700 is associated. For example, the sensors 790 may provide light electric vehicle information to the various systems described herein. The sensors 790 may include a tire pressure sensor, a location sensor, an image sensor, a speed sensor, a tire alignment sensor, a rechargeable battery sensor and so on.

The term computer-readable media as used herein may include computer storage media. Computer storage media may include volatile and nonvolatile, removable and non-removable media implemented in any method or technology for storage of information, such as computer readable instructions, data structures, or program modules.

The system memory 720, the removable storage 760, and the non-removable storage 770 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Examples of the present disclosure describe a method, comprising: receiving a light electric vehicle use request from a computing device associated with an individual; determining, based at least in part, on the light electric vehicle use request, profile information of the individual and a location of the individual; determining, based at least in part, on the profile information of the individual and the location of the individual, an anticipated route of travel of the individual; identifying, using light electric vehicle profile information received from a plurality of light electric vehicles and the profile information of the individual, one or more light electric vehicles associated with the location of the individual and that have a range offering that enables the individual to complete the anticipated route of travel; and providing a location of at least one of the one or more light electric vehicles to the computing device associated with the individual. In some examples, the profile information of the individual comprises one or more of: an average speed of the individual while the individual is riding an light electric vehicle along the anticipated route; an average amount of power input provided by the individual while the individual is riding the light electric vehicle along the anticipated route; and an average payload associated with the individual. In some examples, the light electric vehicle profile information of each of the plurality of light electric vehicles includes a state of charge of a rechargeable battery associated with each of the plurality of light electric vehicles. In some examples, the method also includes determining topography information along the anticipated route of the individual. In some examples, the method also includes generating an alternative route based, at least in part, on the topography information along the route and the range offering of the one or more light electric vehicles associated with the location of the individual; and providing the alternative route to the computing device associated with the individual. In some examples, the alternative route identifies a charging station for a rechargeable battery of the one or more light electric vehicles. In some examples, the method also includes providing an incentive to the individual in response to the individual taking the alternative route. In some examples, the method also includes receiving, from the computing device associated the individual, a selection of one of the one or more light electric vehicles; and updating, in substantially real time, the range offering of the selected one of the one or more light electric vehicles. In some examples, the method also includes providing the updated range offering to the computing device associated with the individual. In some examples, the method also includes generating an alternative route for the individual; and providing the alternative route to the computing device associated with the individual.

In other examples, a method is described. The method comprises receiving a light electric vehicle use request from a computing device associated with an individual; determining, based at least in part, on the light electric vehicle use request, profile information of the individual and a location of the individual; determining, based at least in part, on the profile information of the individual, whether a number of uses of light electric vehicles by the individual is below a threshold; identifying one or more light electric vehicles associated with the location of the individual; selecting an light electric vehicle from the one or more light electric vehicles based, at least in part, on the number of uses of light electric vehicles being below the threshold and on light electric vehicle profile information of the one or more light electric vehicles associated with the location of the individual; and providing a location of the selected light electric vehicle to the computing device associated with the individual. In some examples, the light electric vehicle profile information of the one or more light electric vehicles includes one or more of: an age of each of the one or more light electric vehicles; a maintenance status of each of the one or more light electric vehicles; a state of charge of a rechargeable battery associated with each of the one or more light electric vehicles; and a distance from the location of the individual to a location of each of the one or more light electric vehicles. In some examples, the method also includes sending an instruction to the selected light electric vehicle to activate a visual indicator associated with the light electric vehicle. In some examples, the threshold is five or less.

Also described is a system, comprising: at least one processor; and a memory communicatively coupled to the at least one processor and storing instructions that, when executed by the at least one processor, perform operations. In some examples the operations comprise receiving, from a computing device associated with an individual, a light electric vehicle use request and profile information of the individual; determining a location of the individual; determining, based at least in part on the profile information of the individual, an anticipated use of the light electric vehicle; identifying, based at least in part, on light electric vehicle profile information, an light electric vehicle associated with the location of the individual that will satisfy the anticipated use of the light electric vehicle; and providing a location of the light electric vehicle to the computing device associated with the individual. In some examples, the anticipated use of the light electric vehicle includes an anticipated route of the individual from an origin to a destination. In some examples, the instructions include instructions for receiving one or more time parameters associated with the light electric vehicle use request. In some examples, the instructions include instructions for determining, based at least in part, on the light electric vehicle profile information and the anticipated use of the light electric vehicle, a range offering of the light electric vehicle. In some examples, the instructions include instructions for providing the range offering of the light electric vehicle to the computing device associated with the light electric vehicle. In some examples, the instructions include instructions for dynamically updating the range offering, based at least in part, on an anticipated route of the light electric vehicle.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A method, comprising:
receiving a light electric vehicle use request from a computing device associated with an individual;
determining, based at least in part, on the light electric vehicle use request, profile information of the individual and a location of the individual;
determining, based at least in part, on the profile information of the individual and the location of the individual, an anticipated route of travel of the individual;
identifying, using light electric vehicle profile information received from a plurality of light electric vehicles and the profile information of the individual, one or more light electric vehicles associated with the location of the individual and that have a range offering that enables the individual to complete the anticipated route of travel; and
providing a location of at least one of the one or more light electric vehicles to the computing device associated with the individual.

2. The method of claim 1, wherein the profile information of the individual comprises one or more of:
an average speed of the individual while the individual is riding an light electric vehicle along the anticipated route;
an average amount of power input provided by the individual while the individual is riding the light electric vehicle along the anticipated route; and
an average payload associated with the individual.

3. The method of claim 1, wherein the light electric vehicle profile information of each of the plurality of light electric vehicles includes a state of charge of a rechargeable battery associated with each of the plurality of light electric vehicles.

4. The method of claim 1, further comprising determining topography information along the anticipated route of the individual.

5. The method of claim 4, further comprising:
generating an alternative route based, at least in part, on the topography information along the route and the range offering of the one or more light electric vehicles associated with the location of the individual; and
providing the alternative route to the computing device associated with the individual.

6. The method of claim 5, wherein the alternative route identifies a charging station for a rechargeable battery of the one or more light electric vehicles.

7. The method of claim 5, further comprising providing an incentive to the individual in response to the individual taking the alternative route.

8. The method of claim 1, further comprising:
receiving, from the computing device associated the individual, a selection of one of the one or more light electric vehicles; and
updating, in substantially real time, the range offering of the selected one of the one or more light electric vehicles.

9. The method of claim 8, further comprising providing the updated range offering to the computing device associated with the individual.

10. The method of claim 9, further comprising:
generating an alternative route for the individual; and
providing the alternative route to the computing device associated with the individual.

11. A method, comprising:
receiving a light electric vehicle use request from a computing device associated with an individual;
determining, based at least in part, on the light electric vehicle use request, profile information of the individual and a location of the individual;
determining, based at least in part, on the profile information of the individual, whether a number of uses of light electric vehicles by the individual is below a threshold;
identifying one or more light electric vehicles associated with the location of the individual;
selecting an light electric vehicle from the one or more light electric vehicles based, at least in part, on the number of uses of light electric vehicles being below the threshold and on light electric vehicle profile information of the one or more light electric vehicles associated with the location of the individual; and
providing a location of the selected light electric vehicle to the computing device associated with the individual.

12. The method of claim 11, wherein the light electric vehicle profile information of the one or more light electric vehicles includes one or more of:
an age of each of the one or more light electric vehicles;
a maintenance status of each of the one or more light electric vehicles;
a state of charge of a rechargeable battery associated with each of the one or more light electric vehicles; and
a distance from the location of the individual to a location of each of the one or more light electric vehicles.

13. The method of claim 11, further comprising sending an instruction to the selected light electric vehicle to activate a visual indicator associated with the light electric vehicle.

14. The method of claim 11, wherein the threshold is five or less.

15. A system, comprising:
at least one processor; and
a memory communicatively coupled to the at least one processor and storing instructions that, when executed by the at least one processor, perform operations, comprising:
receiving, from a computing device associated with an individual, a light electric vehicle use request and profile information of the individual;
determining a location of the individual;
determining, based at least in part on the profile information of the individual, an anticipated use of the light electric vehicle;
identifying, based at least in part, on light electric vehicle profile information, an light electric vehicle associated with the location of the individual that will satisfy the anticipated use of the light electric vehicle; and
providing a location of the light electric vehicle to the computing device associated with the individual.

16. The system of claim 15, wherein the anticipated use of the light electric vehicle includes an anticipated route of the individual from an origin to a destination.

17. The system of claim 15, further comprising instructions for receiving one or more time parameters associated with the light electric vehicle use request.

18. The system of claim 15, further comprising instructions for determining, based at least in part, on the light electric vehicle profile information and the anticipated use of the light electric vehicle, a range offering of the light electric vehicle.

19. The system of claim 18, further comprising instructions for providing the range offering of the light electric vehicle to the computing device associated with the light electric vehicle.

20. The system of claim 18, further comprising instructions for dynamically updating the range offering, based at least in part, on an anticipated route of the light electric vehicle.
